(19) United States
(12) Patent Application Publication
(10) Pub. No.: US 2026/0155600 A1
(43) Pub. Date: Jun. 4, 2026

(54) Input Voltage Connector for VPX Power Supply and Power Distribution

(71) Applicant: TE Connectivity Solutions GmbH, Schaffhausen (CH)

(72) Inventors: Kyle Gary ANNIS, Hummelstown, PA (US); Michael James HORNING, Landisville, PA (US)

(73) Assignee: TE Connectivity Solutions GmbH, Schaffhausen (CH)

(21) Appl. No.: 19/383,823

(22) Filed: Nov. 10, 2025

Related U.S. Application Data
(60) Provisional application No. 63/727,367, filed on Dec. 3, 2024.

(51) Int. Cl. H01R 13/53; H01R 12/73; H01R 13/405

(52) U.S. Cl. CPC H01R 13/53; H01R 12/737; H01R 13/405

(57) ABSTRACT

A high voltage having a housing with a mating end and a mounting end. The housing has contact receiving slots with walls which extend between the contact receiving slots. Power contacts are provided in the contact receiving slots. First ribs extend from the walls toward the mating end of the housing. Second ribs extend from the mounting end of the housing. The first ribs, the walls and the second ribs provide a barrier between the power contacts to prevent arcing and provide an increased distance across the surface between adjacent contacts. the second ribs are positioned in slots of a mating substrate as the power connector is mounted on the substrate, allowing the isolation of the power contacts to be continued into the substrate.

### FIELD OF THE INVENTION

The invention relates to an input voltage connector or module which fully isolates between each conductor. In particular, the invention relates to an input voltage connector or module which can be used for multiple applications/voltage rails (i.e., 270V, 3-phase, 28V).

### BACKGROUND OF THE INVENTION

Connectors or modules having contacts for transmitting high voltage thereacross are known. In order to isolate the high voltage contacts, various spacer may be used. Alternatively, coating materials or other types of insulation may be used.

In order to minimize space requirements and provide cost-effective isolation between the high voltage contacts from each other and from any signal contacts, it would be beneficial to provide a housing or housing insert which fully isolates the high voltage contacts.

### SUMMARY OF THE INVENTION

The following provides a summary of certain illustrative embodiments of the present invention. This summary is not an extensive overview and is not intended to identify key or critical aspects or elements of the present invention or to delineate its scope.

An object is to provide a power connector which is configured to support multiple voltage types, including, but not limited to, 270V, 3-phase, 28V.

An object is to provide a power connector with isolation between each contact required to support 3-phase applications (phase A/B/C and neutral).

An object is to provide a power connector which is designed to fit in standard module dimensions, such as, but not limited to, a standard VPX PO module.

An embodiment is directed to an electrical connector module having an input voltage connector having contacts extending therethrough, the contacts being fully isolated from each other. Ribs isolate the power contacts by providing a barrier between contacts to prevent arcing and providing an increased distance across the surface between adjacent contacts.

An embodiment is directed to a power connector having a housing with a mating end and a mounting end. The housing has contact receiving slots with walls which extend between the contact receiving slots. Power contacts are provided in the contact receiving slots. First ribs extend from the walls toward the mating end of the housing. Second ribs extend from the mounting end of the housing. The first ribs, the walls and the second ribs provide a barrier between the power contacts to prevent arcing and provide an increased distance across the surface between adjacent contacts. the second ribs are positioned in slots of a mating substrate as the power connector is mounted on the substrate, allowing the isolation of the power contacts to be continued into the substrate.

An embodiment is directed to a power connector having an outer housing and an inner fin housing. The outer housing has a mating end and a mounting end. The housing has contact receiving slots which are separated by walls. The inner fin housing has inner fin housing slots which are separated by inner fin housing walls. Power contacts are provided in the contact receiving slots and the inner fin housing slots. First ribs extend from the walls of the outer housing toward the mating end of the outer housing. Second ribs extend from the inner fin housing. The second ribs extend beyond the mounting end of the outer housing. The first ribs, the walls and the second ribs provide a barrier between the power contacts to prevent arcing and provide an increased distance across the surface between adjacent contacts. The second ribs are positioned in slots of a mating substrate as the power connector is mounted on the substrate, allowing the isolation of the power contacts to be continued into the substrate.

An embodiment is directed to an electrical connector module having a signal connector with signal contact provided therein and an input voltage connector. A housing of the input voltage connector has a mating end and a mounting end. The housing has contact receiving slots with walls which extend between the contact receiving slots. Power contacts are provided in the contact receiving slots. First ribs extends from the walls toward the mating end of the housing. Second ribs extend from the mounting end of the housing. The first ribs, the walls and the second ribs provide a barrier between the power contacts to prevent arcing, to provide an increased distance across the surface between adjacent contacts, and to provide isolation of the power contacts.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

FIG. 1 is a perspective view of an illustrative embodiment of the present invention illustrating a plug-in module mounted to a daughter card.

FIG. 2 is a perspective view of an illustrative embodiment of the present invention illustrating a backplane module mounted to a backplane.

FIG. 3 is a cross section view of the plug-in module of FIG. 1 mated with the backplane module of FIG. 2.

FIG. 4 is an exploded view of the input voltage connector of the plug-in module of FIG. 1.

FIG. 5 is a cross section view of the assembled plug-in module of FIG. 4.

FIG. 6 is an exploded view of the input voltage connector of the backplane module of FIG. 2.

FIG. 7 is a front view of the plug-in module of FIG. 1.

FIG. 8 is a top view of the plug-in module of FIG. 1.

FIG. 9 is a perspective view of the daughter card on which the plug-in module of FIG. 1 is mounted.

FIG. 10 is a top view of the backplane module of FIG. 2.

FIG. 11 is a perspective view of the backplane on which the backplane module of FIG. 2 is mounted.

FIG. 12 is a perspective view of an illustrative alternate embodiment of a plug-in module mounted to a daughter card.

FIG. 13 is a perspective view of an illustrative alternat backplane module mounted to a backplane.

FIG. 14 is a perspective view of another illustrative alternate embodiment of a plug-in module mounted to a daughter card.

The accompanying drawings, which are incorporated into and form a part of the specification, schematically illustrate one or more exemplary embodiments of the invention and, together with the general description given above and detailed description given below, serve to explain the principles of the invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. In various applications, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

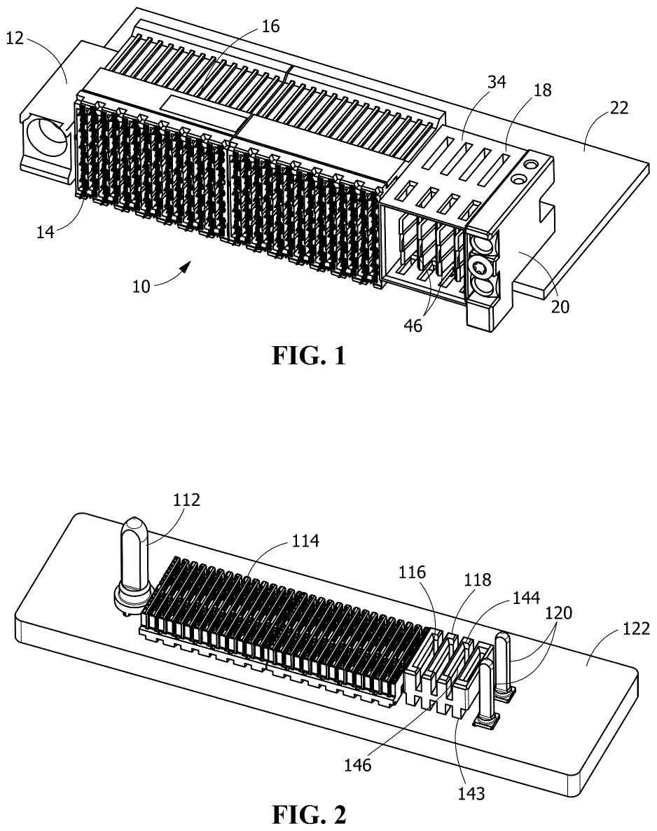

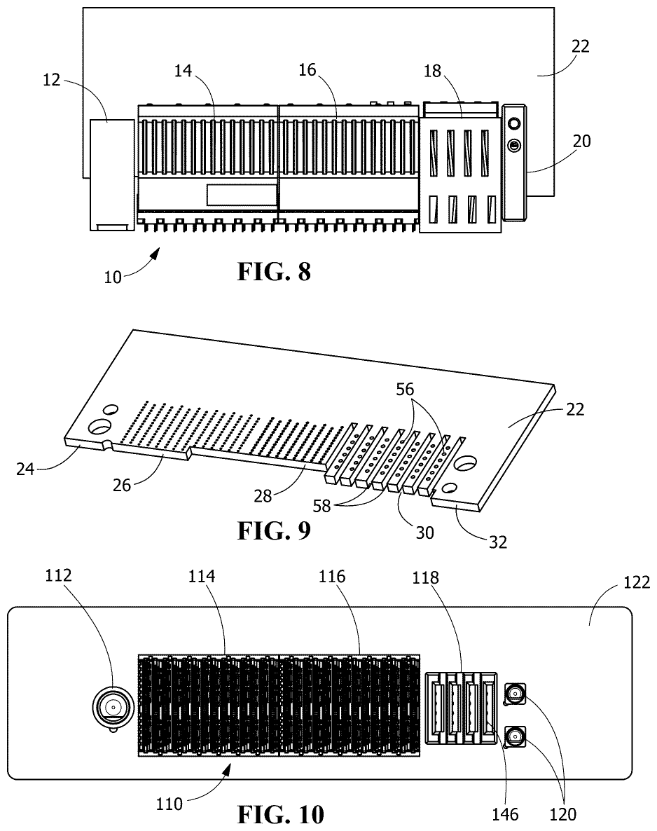

Referring to FIGS. 1, 7 and 8, an illustrative plug-in module 10 includes an alignment/keying member 12, a first signal and output power connector 14 (such as, but not limited to, a TE Connectivity Multigig HD connector), a second signal and output power connector 16 (such as, but not limited to, a TE Connectivity Multigig HD connector), an input voltage connector 18, and a second alignment/keying member 20. The plug-in module 10 shown is meant to be illustrative, as many different configurations of the plug-in module 10 may be used. For example, in the illustrative embodiment shown the alignment/keying member 12, the first signal and output power connector 14, the second signal and output power connector 16, and the second alignment/keying member 20 are known and can be replaced by other components.

The plug-in module 10 is mounted to a daughter card 22. As shown in FIG. 9, the daughter card 22 has five mounting sections. A first mounting section 24 is configured to engage the first alignment/keying member 12. A second mounting section 26 is configured to engage the first signal and output power connector 14. A third mounting section 28 is configured to engage the second signal and output power connector 16. A fourth mounting section 30 is configured to engage the input voltage connector 18. A fifth mounting section 32 is configured to engage the second alignment/keying member 20.

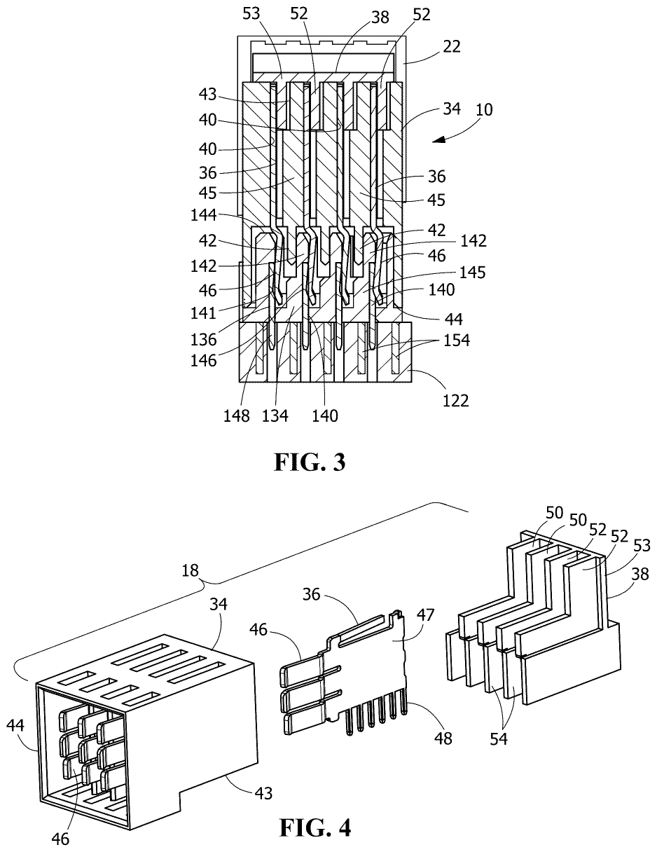

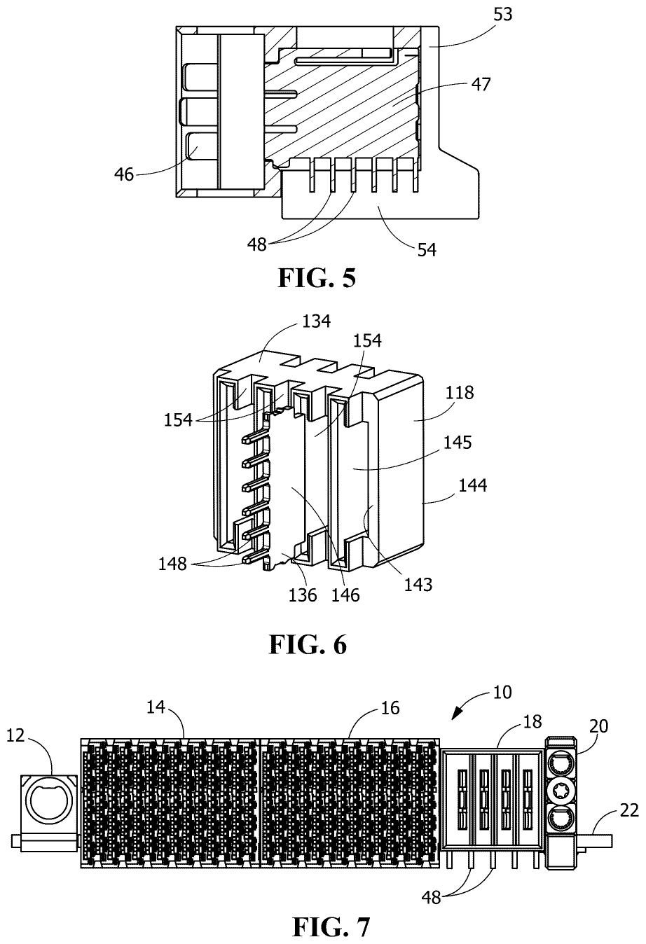

Referring to FIGS. 3 through 5, the illustrative input voltage connector 18 has an outer housing 34, power contacts 36 and inner fin housing 38. The outer housing 34 has slots 40 for receiving the contacts 36 therein. In the illustrative embodiment shown, four slots 40 are shown. The slots 40 extend from a mating end 44 of the outer housing 34 to a mounting end 43 of the outer housing 34. The slots 40 are separated by walls 45. Ribs 42 extend from the walls 45 and extend toward the mating end 44 of the housing 34. Recesses 41 are provided in the walls 45. The recesses 41 are spaced from the ribs 42 and extend toward the mounting end 43 of the outer housing 34.

In the illustrative embodiment shown, four power contacts 36 are shown. The contacts 36 have mating tabs 46, main body portions 47 and compliant pins or solder posts 48. The mating tabs 46 and the compliant pins or solder posts 48 extend in different directions from the main body portion 47. In the illustrative embodiment shown, the compliant pins or solder posts 48 extend from the main body portion 47 at essentially right angles to the mating tabs 46. However, other numbers and configurations of the contacts 36 may be used.

The inner fin housing 38 has slots 50 for receiving portions of the main body portion 47 of the contacts 36 therein. In the illustrative embodiment shown, four slots 50 are shown. The slots 50 are separated by walls 52. The walls 52 extend from a rear wall 53 of the inner fin housing 38. The inner fin housing 38 also has ribs 54 which extend from the walls 52 and are positioned proximate the compliant pins or solder posts 48 of the contacts 36. As shown in FIG. 3, when the inner fin housing 38, contacts 36 and outer housing 34 are assembled, the walls 52 of the inner fin housing 38 are positioned in the recesses 41 of the walls 45 of the outer housing 34 and extend into the slots 40. In the illustrative embodiment, the outer housing 34 and the inner fin housing 38 are separate members or components. However, in other illustrative embodiments, the outer housing 34 and the inner fin housing 38 may be integrally molded as one piece.

The daughter card 22 to which the plug-in module 10 is mounted, is shown in FIG. 9. The fourth mounting section 30, which is configured to engage the input voltage connector 16, has slots 58 positioned between plated through holes or receiving openings 56. The receiving openings 56 are configured to receive the compliant pins or solder posts 48 of the contacts 36. The slots 58 are configured to receive the ribs 54 of the inner fin housing 38.

When the input voltage connector 18 of the plug-in module 10 is properly assembled, the walls 45 and the ribs 42 of the outer housing 34 cooperate with the walls 52 and ribs 54 of the inner fin housing 38 to isolate the mating tabs 46, the main body portions 47 and the compliant pins or solder posts 48 of the power contacts 36 from the other power contacts 36 and from the first signal and output power connector 14 and the second signal and output power connector 16. In 3-phase applications, this allows phase A/B/C and neutral to be isolated from each other. For other power applications, such as, but not limited to, 270V and 28V, the walls 45 and the ribs 42 of the outer housing 34 and the walls 52 and ribs 54 of the inner fin housing 38 provide a barrier between the power contacts 36 to prevent arcing and also providing an increased distance across the surface between adjacent contacts 36.

When the input voltage connector 18 of the plug-in module 10 is mounted to the daughter card 22, the compliant pins or solder posts 48 of the contacts are positioned in receiving openings 56 of the fourth mounting section 30 of the daughter card 22. In addition, the ribs 54 of the inner fin housing 38 are positioned in the slots 58 of the fourth mounting section 30 of the daughter card 22. By positioning the ribs 54 in the slots 58, the isolation of the power contacts 36 is continued into the daughter card 22, facilitating a more reliable connection.

Referring to FIGS. 2 and 10, an illustrative backplane module 110 includes an alignment/keying member 112, a first signal and output power connector 114, a second signal and output power connector 116, an input voltage connector 118, and a second alignment/keying member 120. The backplane module 110 is configured to allow mating with the plug-in module 10. The backplane module 110 shown is meant to be illustrative, as many different configurations of the backplane module 110 may be used. For example, in the illustrative embodiment shown the alignment/keying member 112, the first signal and output power connector 114, the second signal and output power connector 116, and the second alignment/keying member 120 are known and can be replaced by other components.

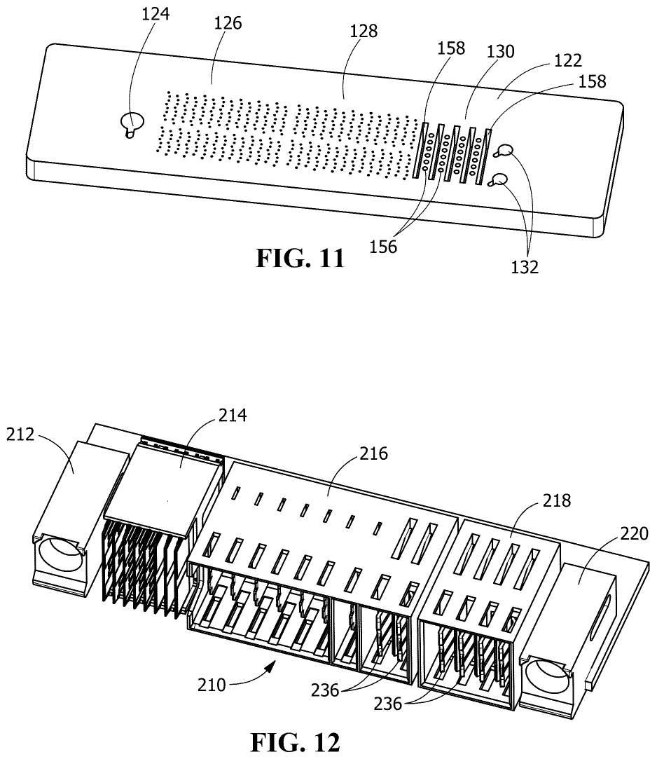

The backplane module 110 is mounted to a backplane 122. As shown in FIG. 11, the daughter card 122 has five mounting sections. A first mounting section 124 is configured to engage the first alignment member 112. A second mounting section 126 is configured to engage the first signal and output power connector 114. A third mounting section 128 is configured to engage the second signal and output power connector 116. A fourth mounting section 130 is configured to engage the input voltage connector 116. A fifth mounting section 132 is configured to engage the second alignment/keying member 118.

Referring to FIGS. 2, 3 and 10, the illustrative input voltage connector 118 has a housing 134 and power contacts 136. The housing 134 has slots 140 for receiving the contacts 134 therein. In the illustrative embodiment, four slots 140 are shown, which correspond to slots 40 of the input voltage connector 18. The slots 140 extend from a mating end 144 of the housing 134 to a mounting end 143 of the housing 134. The slots 140 are separated by walls 145. Ribs 142 extend from the walls 145 and extend toward the mating end 144 of the housing 134. Recesses 141 are provided in the walls 145. The recesses 141 are spaced from the ribs 142 and extend toward the mounting end 143 of the outer housing 134. The recesses 141 are configured to receive the power contacts 136.

In the illustrative embodiment shown, four contact 136 are shown. The contacts 136 have mating portions 146 and compliant pins or solder posts 148. In the illustrative embodiment shown, the mating portion 146 and the compliant pins or solder posts 148 of each contact 136 are positioned essentially in line. However, other numbers and configurations of the contacts 136 may be used.

The housing 134 has ribs 154 which extend from the walls 145 and are positioned proximate the compliant pins or solder posts 148 of the contacts 136. The walls 145 and the ribs 154 may be integrally molded together or may be separate members.

The backplane 122 to which the backplane module 110 is mounted, is shown in FIG. 11. The fourth mounting section 130, which is configured to engage the input voltage connector 116, has slots 158 positioned between plated through holes or receiving openings 156. The receiving openings 156 are configured to receive the compliant pins or solder posts 148 of the contacts 136. The slots 158 are configured to receive the ribs 154 of the housing 134.

When the input voltage connector 118 of the backplane module 110 is properly assembled, the walls 145, ribs 142 and ribs 154 isolate the mating portions 146 and compliant pins or solder posts 148 of the power contacts 136 from the other power contacts 136 and from the first signal and output power connector 114 and the second signal and output power connector 116. In 3-phase applications, this allows phase A/B/C and neutral to be isolated from each other. For other power applications, such as, but not limited to, 270V and 28V, the walls 45 and the walls 145, ribs 142 and ribs 154 provide a barrier between the power contacts 136 to prevent arcing and also providing an increased distance across the surface between adjacent contacts 136.

When the input voltage connector 118 of the backplane module 110 is mounted to the backplane 122, the compliant pins or solder posts 148 of the contacts 136 are positioned in receiving openings 156 of the fourth mounting section 130 of the backplane 122. In addition, the ribs 154 of the housing 134 are positioned in the slots 158 of the fourth mounting section 130 of the backplane 122. By positioning the ribs 154 in the slots 158, the isolation of the power contacts 136 is continued into the backplane 122, facilitating a more reliable connection.

As shown in FIG. 3, when the plug-in connector 10 and the backplane connector 110 are mated, the ribs 42 of the outer housing 34 and the ribs 142 of the housing 134 provides a barrier between the mating contacts 36, 136 to prevent arcing and to provide an increased distance across the surface between adjacent contacts.

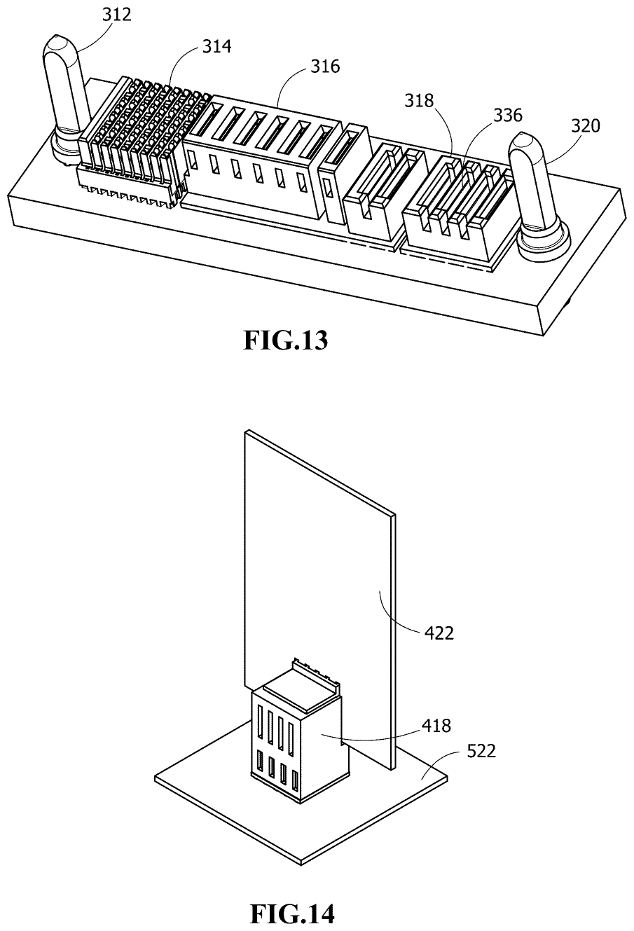

FIGS. 12 and 13 show an second illustrative embodiment. In this illustrative embodiment, the configuration of the alignment/keying alignment member 212, the first signal and output power connector 214, the second signal and output power connector 216, the input voltage connector 218, and the second alignment/keying member 220 may vary from the alignment/keying alignment member 12, the first signal and output power connector 14, the second signal and output power connector 16, the input voltage connector 18, and the second alignment/keying member 20 of the above described embodiment, but the operation of the input voltage connector 218 remains the same as the operation of the input voltage connector 18. In this embodiment, the input voltage connector 218 and the second signal and output power connector 216 include power contacts 236. Each of the power contacts 236 is surrounded by an outer housing and an inner fin housing as described above with reference to the first embodiment.

Similarly, the configuration of the alignment/keying alignment member 312, the first signal and output power connector 314, the second signal and output power connector 316, the input voltage connector 318, and the second alignment/keying member 320 may vary from the alignment/keying alignment member 112, the first signal and output power connector 114, the second signal and output power connector 116, the input voltage connector 118, and the second alignment/keying member 120 of the above describe embodiment, but the operation of the input voltage connector 318 remains the same. In this embodiment, the input voltage connector 318 and the second signal and output power connector 316 include power contacts 336. Each of the power contacts 336 is surrounded by a housing as described above with reference to the first embodiment.

FIG. 14 shows a third illustrative embodiment. In this embodiment the voltage connector 418 is independent of other connector and is mounted on the daughter card 422 and the voltage backplane 522 The components and operation of the voltage connector 418 are similar to those described above with respect to voltage connector 18.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed:

1. A power connector comprising:
a housing having a mating end and a mounting end, the housing having contact receiving slots, walls extending between the contact receiving slots;
power contacts provided in the contact receiving slots;
first ribs extending from the walls, the ribs extending from the walls toward the mating end of the housing;
second ribs extending from the mounting end of the housing;
wherein the first ribs, the walls and the second ribs provide a barrier between the power contacts to prevent arcing and provide an increased distance across the surface between adjacent contacts; and
wherein the second ribs are positioned in slots of a mating substrate as the power connector is mounted on the substrate, allowing the isolation of the power contacts to be continued into the substrate.

2. The power connector as recited in claim 1, wherein the housing has an outer housing and an inner fin housing, the walls and the first ribs are provided on the outer housing and the second ribs are provided on the inner fin housing.

3. The power connector as recited in claim 2, wherein the inner fin housing has inner fin housing slots for receiving portions of the power contacts therein, the inner fin housing slots are separated by inner fin housing walls.

4. The power connector as recited in claim 3, wherein the second ribs extend from the inner fin housing walls.

5. The power connector as recited in claim 4, wherein the power contacts have mating tabs, main body portions and mounting portions, the mating tabs are positioned proximate the first ribs and the mounting portions are positioned proximate the second ribs.

6. The power connector as recited in claim 5, wherein the walls of the outer housing have recesses spaced from the first ribs and extend toward the mounting end of the housing.

7. The power connector as recited in claim 6, wherein portions of the inner fin housing walls are positioned in the recesses of the walls of the outer housing.

8. A power connector comprising:
an outer housing having a mating end and a mounting end, the housing having contact receiving slots, the contact receiving slots being separated by walls;
an inner fin housing, the inner fin housing having inner fin housing slots, the inner fin housing slots being separated by inner fin housing walls;
power contacts provided in the contact receiving slots and the inner fin housing slots;
first ribs extending from the walls of the outer housing, the ribs extending from the walls toward the mating end of the outer housing;
second ribs extending from the inner fin housing, the second ribs extending beyond the mounting end of the outer housing;
wherein the first ribs, the walls and the second ribs provide a barrier between the power contacts to prevent arcing and provide an increased distance across the surface between adjacent contacts; and
wherein the second ribs are positioned in slots of a mating substrate as the power connector is mounted on the substrate, allowing the isolation of the power contacts to be continued into the substrate.

9. The power connector as recited in claim 8, wherein the power contacts have mating tabs, main body portions and mounting portions, the mating tabs are positioned proximate the first ribs and the mounting portions are positioned proximate the second ribs.

10. The power connector as recited in claim 9, wherein the walls of the outer housing have recesses spaced from the first ribs and extending toward the mounting end of the housing.

11. The power connector as recited in claim 10, wherein portions of the inner fin housing walls are positioned in the recesses of the walls of the outer housing.

12. An electrical connector module comprising:
a signal connector having signal contacts provided therein;
an input voltage connector, the input voltage connector comprising:
a housing having a mating end and a mounting end, the housing having contact receiving slots, walls extending between the contact receiving slots;
power contacts provided in the contact receiving slots;
first ribs extending from the walls, the ribs extending from the walls toward the mating end of the housing;
second ribs extending from the mounting end of the housing;
wherein the first ribs, the walls and the second ribs provide a barrier between the power contacts to prevent arcing, to provide an increased distance across the surface between adjacent contacts, and to provide isolation of the power contacts.

13. The electrical connector module as recited in claim 12, wherein the electrical connector module is mounted to a daughter card.

14. The electrical connector module as recited in claim 13, wherein the daughter card has a mounting section for engaging the input voltage connector, the mounting section having rib receiving slots, the rib receiving slots configured to receive the second ribs of the input voltage connector therein.

15. The electrical connector module as recited in claim 14, wherein the housing has an outer housing and an inner fin housing, the walls and the first ribs are provided on the outer housing and the second ribs are provided on the inner fin housing.

16. The electrical connector module as recited in claim 15, wherein the inner fin housing has inner fin housing slots for receiving portions of the power contacts therein, the inner fin housing slots are separated by inner fin housing walls.

17. The electrical connector module as recited in claim 16, wherein the second ribs extend from the inner fin housing walls.

18. The electrical connector module as recited in claim 17, wherein the power contacts have mating tabs, main body portions and mounting portions, the mating tabs are positioned proximate the first ribs and the mounting portions are positioned proximate the second ribs.

19. The electrical connector module as recited in claim 18, wherein the walls of the outer housing have recesses spaced from the first ribs and extending toward the mounting end of the housing.

20. The electrical connector module as recited in claim 20, wherein portions of the inner fin housing walls are positioned in the recesses of the walls of the outer housing.
